(19) United States
(12) Patent Application Publication
(10) Pub. No.: US 2016/0282889 A1
(43) Pub. Date: Sep. 29, 2016

(54) LINEAR AND NON-LINEAR CONTROL FOR DIGITALLY-CONTROLLED LOW-DROPOUT CIRCUITRY

(71) Applicants: Tarun Mahajan, Bangalore (IN); Dheeraj Shetty, Bangalore (IN); Ramnarayanan Muthukaruppan, Bangalore (IN)

(72) Inventors: Tarun Mahajan, Bangalore (IN); Dheeraj Shetty, Bangalore (IN); Ramnarayanan Muthukaruppan, Bangalore (IN)

(21) Appl. No.: 14/669,480

(22) Filed: Mar. 26, 2015

(51) Int. Cl. G05F 1/575

(52) U.S. Cl. CPC G05F 1/575

(57) ABSTRACT

Some embodiments include apparatuses and methods having a power switching unit to receive a first voltage and provide a second voltage, and a control unit. The control unit can generate control information to control the power switching unit such that a value of the second voltage is less than a value of the first voltage. The control unit can also generate error correction information having a value based on a value of an error in the second voltage. The control unit can operate in a first mode if the error has a value less than a value of a threshold information and in a second mode if the error has a value greater than the value of the threshold information. The control unit can adjust the value of the control information by an amount proportional to the value of the error correction information in the second mode.

### TECHNICAL FIELD

Embodiments described herein pertain to power management in electronic systems. Some embodiments relate to voltage regulators.

### BACKGROUND

Many electronic devices or systems, such as computers, tablets, and cellular phones, have a power management unit (e.g., a voltage regulator) to control voltage in the device or system. The power management unit may regularly monitor the value of voltage (e.g., supply voltage) in the system order to maintain the voltage at a target value. During some events (e.g., during load transients) or during certain control modes (e.g., non-linear mode), some conventional power management schemes, however, may suffer from one or more of the following: large droop in the output voltage level, large output voltage over-shoots and under-shoots, slow response in output voltage recovery, and longer output voltage settling time.

### BRIEF DESCRIPTION OF THE DRAWINGS

FIG. 1 shows an apparatus including voltage controller and a load, according to some embodiments described herein.

FIG. 2 shows a block diagram of an error correction information generator of the voltage controller of FIG. 1, according to some embodiments described herein.

FIG. 3 shows a block diagram of time-to-digital converters of the error correction information generator FIG. 2, according to some embodiments described herein.

FIG. 4 shows a non-linear entry decision logic of the voltage controller of FIG. 1, according to some embodiments described herein.

FIG. 5 shows a block diagram of the non-linear control code generator of the voltage controller of FIG. 1, according to some embodiments described herein.

FIG. 6 shows the block diagram of a linear control code generator of the voltage controller of FIG. 1, according to some embodiments described herein.

FIG. 7 shows an example timing diagram for some of the error correction information and signals associated with an operation of the voltage controller of FIG. 1 through FIG. 6 in response to a load step having a relatively large value, according to some embodiments described herein.

FIG. 8 shows another example timing diagram for some of the error correction information and signals associated with an operation of the voltage controller of FIG. 1 through FIG. 6 in response to a load step having a relatively small value, according to some embodiments described herein.

FIG. 9 shows an example timing diagram for some of the error correction information and signals associated with an operation of the voltage controller of FIG. 1 through FIG. 6 when a non-linear mode is disabled, according to some embodiments described herein.

FIG. 10 is a flow diagram showing a method of controlling a voltage, according to some embodiments described herein.

### DETAILED DESCRIPTION

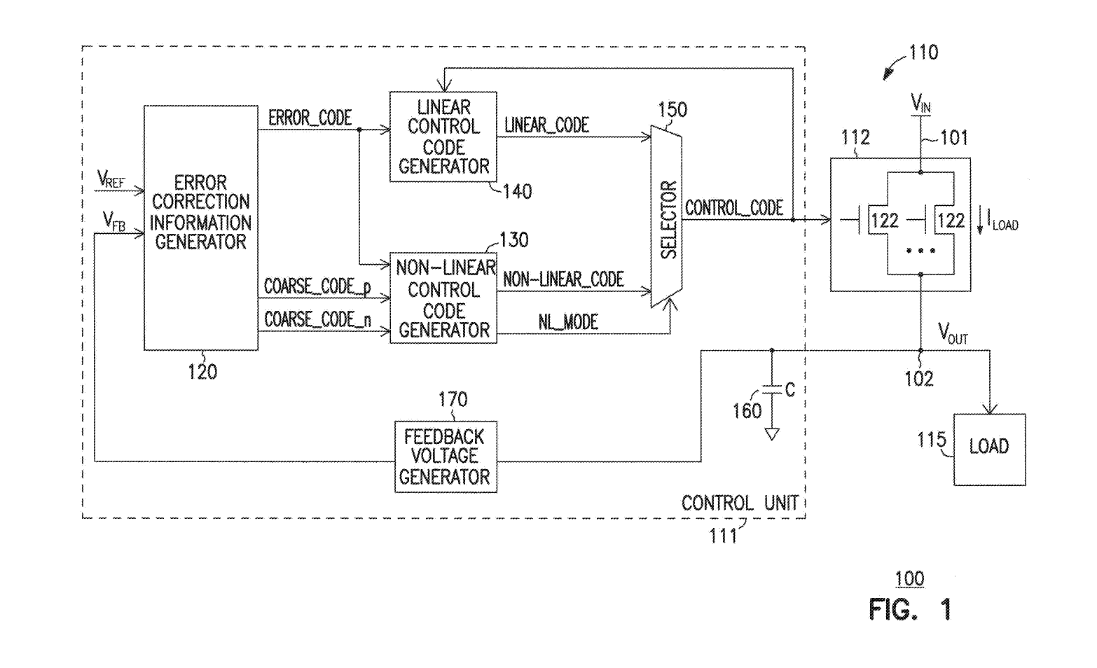

FIG. 1 shows an apparatus 100 including a voltage controller 110 and a load 115, according to some embodiments described herein. Apparatus 100 can include or be included in an electronic device or system, such as a computer (e.g., desktop, laptop, or notebook), a tablet, a cellular phone, wearable electronics (e.g., smart watches), or other electronic devices or systems.

As shown in FIG. 1, voltage controller 110 can include a control unit 111 to generate control information (e.g., digital code) Control_Code to control a power switching unit 112. Control unit 111 can monitor and detect an error in the value of voltage V_{OUT} to control (e.g., adjust) the value of information Control_Code in order to maintain the value of voltage V_{OUT} at a target value. The target value can be a voltage value within a target value range (e.g., a pre-determined value range).

Power switching unit 112 can be controlled by control unit 111 such that a difference in values between voltages V_{IN} and V_{OUT} is relatively small (e.g., low drop-out (LDO)). Thus, the value of V_{OUT} can be less than the value of voltage V_{IN} by a relatively small amount. Therefore, voltage controller 110 can operate as a low-drop out (LDO) voltage regulator.

Load 115 may use voltage V_{OUT} as its supply voltage (e.g., regulated supply voltage). Load 115 can include or be included in a functional unit such as a processor (e.g., a central processing unit (CPU)), a memory device, or other functional units. Voltage controller 110 and load 115 can be located on (e.g., formed in, formed on, or integrated in) the same integrated circuit (IC) die (e.g., and IC chip). The IC die can include a semiconductor die (e.g., a silicon die). Alternatively, voltage controller 110 and load 115 can be located on different IC dice. For example, voltage controller 110 can be located on one IC die on a circuit board (e.g., motherboard), and load 115 can be located on another IC die on the circuit board. Apparatus 100 can include or be included in a system on chip (SoC), such that voltage controller 110 and load 115 can be included (e.g., integrated) in the SoC.

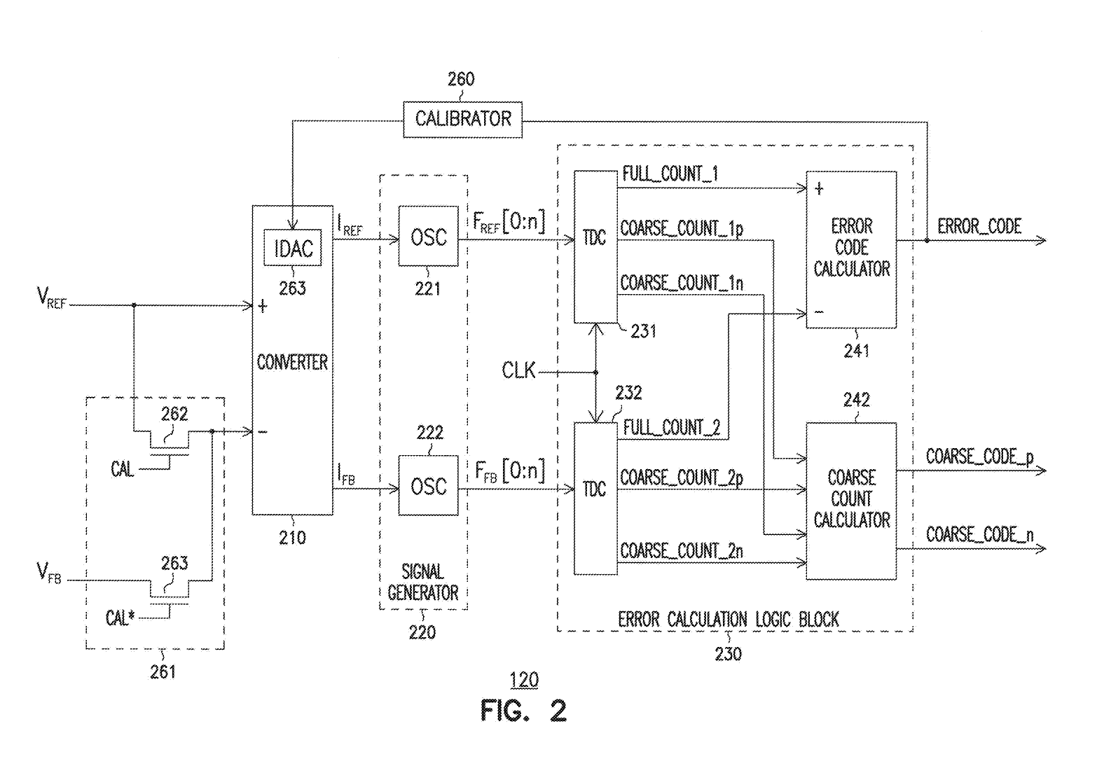

Voltage controller 110 can operate in a linear mode (e.g., steady state mode) and a non-linear mode. Voltage controller 110 can operate in the linear mode if an error in voltage V_{OUT} has a value less than a specific value (e.g., less than a pre-determined value). Voltage controller 110 can change from the linear mode to the non-linear mode if the error in voltage V_{OUT} has a value greater than that specific value (e.g., greater than the pre-determined value). The error that causes the voltage controller 110 to change from the linear mode to the non-linear mode may include a droop in the level in voltage V_{OUT}. Such a droop may occur during a load transient event at load 115. A load transient event may occur when load 115 changes from one operating state (e.g., an idle state) to another operating state (e.g., an active state). As described in more detail with reference to FIG. 2 through FIG. 10 voltage controller 110 can adaptively and dynamically correct an error (e.g., a droop) in voltage V_{OUT} until the value of voltage V_{OUT} returns to a target value.

As shown in FIG. 1, control unit 111 can include an error correction information generator 120, a non-linear control code generator 130, a linear control code generator 140, a selector 150 (e.g., a multiplexer), a capacitor (e.g., load capacitor) 160, and a feedback voltage generator 170. These components are arranged to form digitally-controlled LDO circuitry in closed-loop to control the value of voltage V_{OUT} in both linear and non-linear modes of voltage controller 110.

Error correction information generator 120 can receive voltages V_{FB} and V_{REF}. The value of voltage V_{FB} can be generated based on the value of voltage V_{OUT}. For example, voltage V_{FB} can be a divided version of voltage V_{OUT}. The value of voltage V_{REF} can be generated based on VID (identification voltage) input information (e.g., input code), which can also be based on the value (e.g., target value) of voltage V_{OUT}. A digital-to-analog converter (DAC), not shown in FIG. 1, can be used to generate voltage V_{REF}. A bandgap-based reference voltage (not shown) may be used for the DAC to improve DC accuracy of voltage V_{REF}.

Error correction information generator 120 can operate to generate error correction information (e.g., digital code) Error_Code, Coarse_Code_p, and Coarse_Code_n. The values of these information are proportional to the value of an error in voltage V_{OUT}. A difference in values (e.g., delta V) between voltages V_{FB} and V_{REF} (e.g., delta V=V_{FB}−V_{REF}) is proportional to the value of the error in voltage V_{OUT}. For example, a higher value of the error can result in a higher value in delta V. This leads to higher values for information Error_Code, Coarse_Code_p, and Coarse_Code_n. A lower value of the error can result in a lower value of delta V, which leads to lower values for information Error_Code, Coarse_Code_p, and Coarse_Code_n.

As described in more detail with reference to FIG. 2 through FIG. 6, control unit 111 may use information Error_Code, Coarse_Code_p, and Coarse_Code_n to control (e.g., adjust) the value of information Control_Code in order to keep the value of voltage V_{OUT} at a target value. For example, in the non-linear mode, control unit 111 may adjust the value of information Control_Code by an amount having a value proportional to the value of information Error_Code, Coarse_Code_p, and Coarse_Code_n. Control unit 111 may use information Coarse_Code_p, and Coarse_Code_n (e.g., coarse code error) in only the non-linear mode to perform a coarse correction (e.g., coarse tuning correction) of an error in voltage V_{OUT}. Control unit 111 may use information Error_Code in both linear and non-linear modes to perform a fine correction (e.g., fine tuning correction) of an error in voltage V_{OUT}.

As shown in FIG. 1, non-linear control code generator 130 can operate to generate information (e.g., digital code) Non-Linear_Code based on information Error_Code, Coarse_Code_p, and Coarse_Code_n.

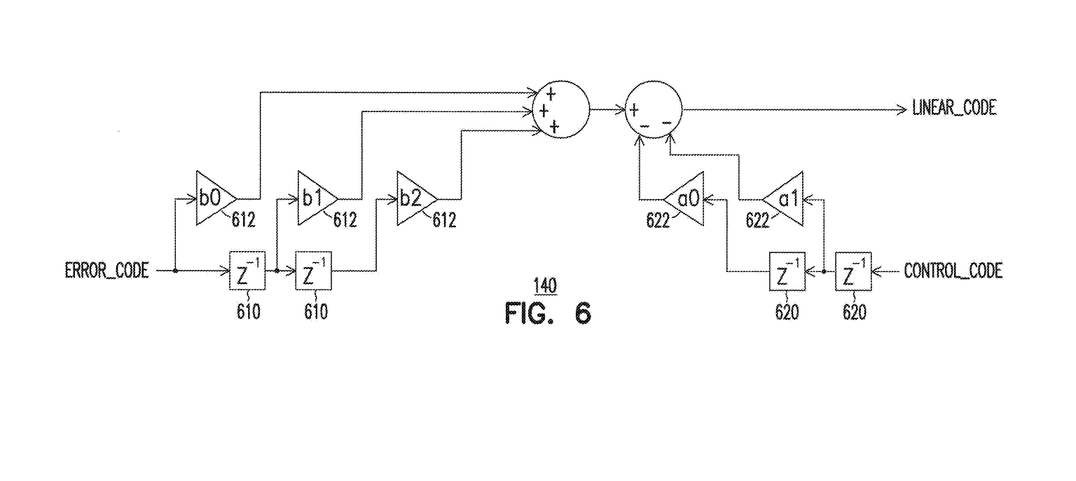

Linear control code generator 140 can operate to generate information (e.g., digital code) Linear_Code based on information Error_Code. Linear control code generator 140 can include a digital controller (e.g., type-2 digital filter). Linear control code generator 140 can also receive information Control_Code as a non-linear write back, as described in more detail below with reference to FIG. 6. The non-linear write back may allow the value of information Linear_Code to be at least equal to the value of information Non-Linear_Code during the non-linear mode. Thus, when voltage controller 110 changes from the non-linear mode to the linear mode, linear control code generator 140 can begin where non-linear control code generator 130 ended. This may prevent a sudden jump in the value of information Control_Code.

Non-linear control code generator 130 can also generate a signal NL_Mode (non-linear mode enable signal). Depending on which mode (e.g., linear or non-linear) control unit 111 operates, selector 150 can respond to the NL_Mode signal to select either information Linear_Code or information Non-Linear_Code to be information Control_Code. Control unit 111 can use information Control_Code to control power switching unit 112 in order to provide appropriate current (e.g., ‘LOAD) and voltage (e.g., V_{OUT}) at node 102. Information Control_Code can include a number of bits.

Power switching unit 112 can include transistors (e.g., power transistors) 122 arranged (e.g., in parallel) between nodes 101 and 102. FIG. 1 shows only two transistors 122 for simplicity. Power switching unit 112 can include a different number of transistors 122. Each of transistors 122 can have a resistance R_{ON} when it is turned on. The relationship between voltages V_{OUT} and V_{IN} can be expressed by an equation V_{OUT}=V_{IN}−(I_{LOAD}*R_{ON-TOTAL}), where R_{ON-TOTAL} is the total resistance of a selected number of transistor among transistors 122 that are turned on. As described above, voltage V_{OUT} has a target value (e.g., the value of voltage V_{OUT} in a steady state within a target value range). Information Control_Code can be used to select an appropriate value for resistance R_{ON-TOTAL} in order to maintain the value of voltage V_{OUT} at target value.

Some events (e.g., load transient events) may cause an error in voltage V_{OUT}. The error may cause the value of V_{OUT} to be outside the target value range. Control unit 111 can detect the error and adjust the value of information Control_Code in order to adjust the resistance (e.g., R_{ON-TOTAL}) between nodes 101 and 102. Since V_{OUT}=V_{IN}−(I_{LOAD}*R_{ON-TOTAL}), adjusting the value of resistance R_{ON-TOTAL} can effectively adjust the value of voltage V_{OUT}. If an error occurs, control unit 111 may adjust the value of information Control_Code more than once until the value of voltage V_{OUT} returns to the target value.

In an example implementation of control unit 111, transistors 122 can be binary-weighted transistors that can provide a range of resistance (e.g., a range of R_{ON-TOTAL}) between nodes 101 and 102. In this example, each of transistors 122 can be controlled by one bit among the bits of information Control_Code. Thus, different combinations (e.g., binary combinations) of bits of information Control_Code can result in different values for the resistance (e.g., R_{ON-TOTAL}) between nodes 101 and 102. For example, if information Control_Code includes 10 bits, then transistors 122 can be structured (e.g., sized) to have a range of resistance that can provide 2¹⁰=1024 possible resistance values (e.g., 1024 different values for R_{ON-TOTAL}). In this example, the value of the 10 bits of information Control_Code can be selected with an initial value, such that the target value of voltage V_{OUT} satisfies the relationship V_{OUT}=V_{IN}−(I_{LOAD}*R_{ON-TOTAL}). If an error in voltage V_{OUT} occurs and causes the value of voltage V_{OUT} to be outside a target value range, then the value of the 10 bits of information Control_Code in this example can be adjusted (e.g., increased or decreased) in or order to adjust (e.g., decrease or increase) the value of resistance R_{ON-TOTAL}, so that the value of V_{OUT} can return to the target value.

Transistors 122 can include field-effect transistors (FETs). Examples of field-effect transistors include n-channel metal-oxide semiconductor (MOS) FETs (e.g., NMOS transistors) and p-channel MOSFETs (e.g., PMOS transistors).

The value of capacitor 160 at node 102 can be selected to provide stability for voltage V_{OUT}. Capacitor 160 can be an on-die capacitor (e.g., located on an IC die where voltage controller 110 is located). Alternatively, capacitor 160 can be an off-die capacitor, which can be located outside an IC die where voltage controller 110 is located (e.g., located on a circuit board). In an example arrangement of voltage controller 110, capacitor 160 can have a value of approximately 20 nF to 25 nF for a specified value of voltage V_{OUT} of approximately 1V.

Feedback voltage generator 170 can operate to provide voltage V_{FB} based on voltage V_{FB}. The value of voltage V_{FB} can be less than the value of voltage V_{OUT}. For example, feedback voltage generator 170 can include a voltage divider to generate voltage V_{FB}, such that voltage V_{FB} is a divided version of voltage V_{OUT}. This may allow voltage V_{FB} to hit the common-mode range of a voltage-to-current converter (FIG. 2) to obtain linear gain.

As described in detail below with reference to FIG. 2 through FIG. 6, voltage controller 110 uses information Coarse_Code_p and Coarse_Code_n during the non-linear mode to determine an initial step in turning on a selected number of transistors 122 in a coarse correction of an error in voltage V_{OUT} in the non-linear mode. Voltage controller 110 uses information Error_Code to determine an additional step in turning on a selected number of transistors 122 in a fine correction of an error in voltage V_{OUT} in either linear or non-linear mode.

As described below with reference to FIG. 2 through FIG. 10, voltage controller 110 (including the digitally-controlled linear and linear mode scheme) may reduce the value of an error (e.g., a first droop during a load transient event) in voltage V_{OUT} and may improve dynamic response of voltage controller 110. The scheme described herein is adaptive in nature to the slew-rate and duration of the load step (associated with current I_{LOAD}) and to the amount of load step at node 102. The scheme described herein may prevent oscillations, over-shoots, or both, in voltage V_{OUT} when voltage controller 110 operates to recover the value voltage V_{OUT} in the non-linear mode. The settling time of voltage V_{OUT} may be much shorter than the output settling time in some conventional schemes.

The scheme described herein may also reduce the value of a droop in voltage V_{OUT} (e.g., a first droop caused by a load transient event), such that the value of the first droop may be less than (e.g., almost one-half less than) the value of a first droop in some conventional schemes. As described with reference to FIG. 2 through FIG. 10, the droop reduction in voltage controller 110 can include detecting a droop or load step in one-half period of the sampling clock without much power over-head to handle large di/dt load steps.

Other improvements of voltage controller 110 are described below with reference to FIG. 1 through FIG. 10.

FIG. 2 shows a block diagram of error correction information generator 120 of FIG. 1, according to some embodiments described herein. As shown in FIG. 2, error correction information generator 120 can include a converter (e.g., a high resolution voltage-to-current converter) 210 to convert voltage V_{REF} into a current I_{REF} and voltage V_{FB} into a current I_{FB}, a signal generator 220 (including oscillators 221 and 222), and an error calculation logic block 230. Converter 210, signal generator 220, and error calculation logic block 230 are arranged such that error correction information generator 120 can operate as an oscillator-based ADC (analog-to-digital converter) to generate information (error correction information) Error_Code, Coarse_Code_p, and Coarse_Code_n) based voltages V_{REF} and V_{FB}.

Each of oscillators 221 and 222 can include a current-controlled oscillator (ICO). Oscillator 221 can operate to generate signals _{FREF} [0:n] (signal F_{REF} [0] through signal F_{REF} [0]) based on current I_{REF}, such that the frequency of the F_{REF} [0:n] signals is based on the value of current I_{REF}. Oscillator 221 can include multiple stages to provide the F_{REF} [0:n] signals having multiple phases. For example, oscillator 221 can include an ICO having five stages (e.g., stage [0] through stage [4]) to generate five F_{REF} [0:4] signals (signal F_{REF} [0] through F_{REF} [4]). Each of the five the F_{REF} [0:4] signals can be provided at the output of one of the five stages of the ICO, such that the five F_{REF} [0:4] signals can have five different phases.

Oscillator 222 can operate to generate signals F_{FB} [0:n] based on current I_{FB}, such that the frequency of the F_{FB} [0:n] signals is based on the value of current I_{FB}. Oscillator 222 can include multiple stages to provide the F_{FB} [0:n] signals having multiple phases. For example, oscillator 222 can include an ICO having five stages to generate five F_{FB} signals (signal F_{FB} [0] through F_{FB} [4]). Each of the five F_{FB} [0:4] signals can be provided at the output of one of the five stages of the ICO, such that the five F_{FB} [0:4] signals can have five different phases.

Error correction information generator 120 can include a time-to-digital converter (TDC) TDC 231 and a TDC 232. TDC 231 can operate to generate digital information Full_Count_1 based on timing information (e.g., based on frequency and phase) of the F_{REF} [0:n] signals, and generate information Coarse_Count_1p and Coarse_Count_1n based on timing information (e.g., based on only the frequency) of the F_{REF} [0:n] signals.

TDC 232 can operate to generate digital information Full_Count_2 based on timing information (e.g., frequency and phase) of the F_{FB} [0:n] signals, and generate information Coarse_Count_2p and Coarse_Count_2n based on timing information (e.g., only the frequency) of the F_{FB} [0:n] signals.

TDC 231 and TDC 232 can receive a signal (e.g., sampling clock signal) CLK signal. The values of information Full_Count_1 and Full_Count_2 can be updated at every rising (e.g., positive) edge of the CLK signal. The values of information Coarse_Count_1p and Coarse_Count_2p can updated at every rising edge of the CLK signal. The values of information Coarse_Count_1n and Coarse_Count_2n can updated at every falling (e.g., negative) edge of the CLK signal.

Error correction information generator 120 can include an error code calculator 241 to generate information Error_Code based on information Full_Count_1 and Full_Count_2. The value of information Error_Code can be based on a difference in values between information Full_Count_1 and Full_Count_2. The value of information Error_Code can be updated at every rising edge of the CLK signal.

Error correction information generator 120 can include a coarse code calculator 242 to generate information Coarse_Code_p and Coarse_Code_n. The value of information Coarse_Code_p can based on a difference in values between information Coarse_Count_1p and Coarse_Count_2p. The value of information Coarse_Code_n can be based on a difference in values between information Coarse_Count_1n and Coarse_Count_2n.

In operation, a change in voltage V_{OUT} (FIG. 1) and can result in a difference in values (e.g., delta V) between voltages V_{FB} and V_{REF}, which leads to a difference in values (e.g., delta I) between current I_{FB} and current I_{REF} (e.g., delta I=I_{FB}−I_{REF}). The value of delta I is proportional to the value of delta V. The gain of converter 210 can be tuned to obtain appropriate resolution and can be programmable. The difference in values between current I_{FB} and current I_{REF} (e.g., delta I) results in a difference in the frequencies, in phases, or in both frequencies and phases, between the F_{REF} [0:n] signals and F_{FB} [0:n] signals. These differences between the F_{REF} [0:n] and F_{FB} [0:n] signals are proportional to the value of the error in voltage V_{OUT}. Based on these differences between the F_{REF} [0:n] and F_{FB} [0:n] signals, voltage controller 110 operate to generate error correction information (Error_Code, Coarse_Code_p, and Coarse_Code_n) to correct the error.

As shown in FIG. 2, error correction information generator 120 can also include a calibrator (e.g., calibration circuitry) 260 and a switching circuit (e.g., multiplexer) 261 including transistors 262 and 263. Calibrator 260 and switching circuit 261 can be used to perform a calibration operation in order to set an initial value (e.g., a value of zero) for information Error_Code. The calibration operation can be automatically performed by voltage controller 110 and can be performed periodically.

During a calibration operation, the inputs (e.g., inputs (+) and (−)) of converter 210 can be provided with the same values, so that the difference in values between currents I_{REF} and I_{FB} can be zero to cause the value of information Error_Code to be zero. For example, during a calibration operation, signals CAL and CAL* can be activated such that transistor 262 can be turned on and transistor 263 can be turned off. This causes inputs (+) and (−) to be shorted together (e.g., electrically coupled together) through transistor 112. In some situations, the value of information Error_Code may be non-zero even with inputs (+) and (−) shorted together because of potential random/systematic offset seen in information Error_Code at node 102. Calibrator 260 can operate to remove such random/systematic offset by, for example, trimming the current in the V-I legs using an I-DAC 263 in converter 210 until the value of information Error_Code is zero. The calibration operation may improve the accuracy of error correction information generator 120.

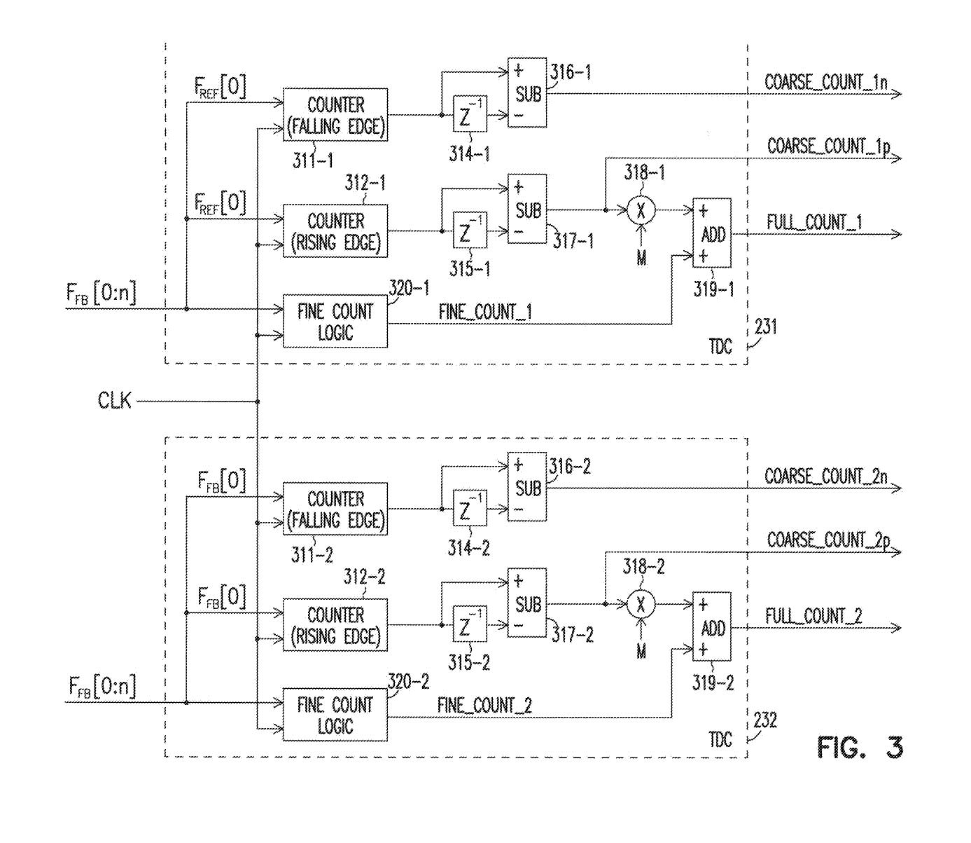

FIG. 3 shows a block diagram of TDC 231 and TDC 232 of FIG. 2, according to some embodiments described herein. As shown in FIG. 3, TDC 231 and TDC 232 can include similar or identical components. For example, TDC 231 can include counters 311-1 and 312-1, a fine count logic 320-1, delay elements 314-1 and 315-1, subtractors 316-1 and 317-1, a multiplier 318-1, and an adder 319-1. TDC 232 can include counters 311-2 and 312-2, a fine count logic 320-2, delay elements 314-2 and 315-2, subtractors 316-2 and 317-2, a multiplier 318-2, and an adder 319-2.

Counter 311-1 can include a free-running counter to count the number of cycles of the F_{REF} [0] signal (one of the F_{REF} [0:n] signals generated by oscillator 221 in FIG. 2) within one period (sampling period) of the CLK signal between two consecutive rising edges of the CLK signal. Counter 311-1, delay element 314-1, and subtractor 316-1 are arranged to generate information Coarse_Count_1n.

Counter 312-1 can include a free-running counter to count the number of cycles of signal of the F_{REF} [0] signal within one period of the CLK signal between two consecutive falling edges of the CLK signal. Counter 312-1, delay element 315-1, and subtractor 317-1 are arranged to generate information Coarse_Count_1p.

Counter 311-2 can include a free-running counter to count the number of cycles of the F_{FB} [0] signal (one of the F_{FB} [0:n] signals generated by oscillator 222 in FIG. 2) within one period of the CLK signal between two consecutive rising edges of the CLK signal. Counter 311-2, delay element 314-2, and subtractor 316-2 are arranged to generate information Coarse_Count_2n.

Counter 312-2 can include a free-running counter to count the number of cycles of signal of the F_{FB} [0] signal within one period of the CLK signal between two consecutive falling edges of the CLK signal. Counter 312-2, delay element 315-2, and subtractor 317-2 are arranged to generate information Coarse_Count_2p.

As an example, the F_{REF} [0:n] signals and the F_{FB} [0:n] signals can have a range of 1 Ghz to 6 Ghz based on output voltage error in V_{OUT}. The CLK signal can have a frequency (e.g., sampling frequency) of approximately 400 Mhz. Thus, the period (sampling period) of the CLK signal can be approximately 2.5 ns.

At the set point of oscillators 221 and 222, the frequencies of the F_{REF} [0:n] and F_{FB} [0:n] signals can match close to the middle frequency (e.g., 3.6 GHz). Information Coarse_Code_p1, Coarse_Count_1n, Coarse_Count_2p, and Coarse_Count_2n can be generated (e.g., initially generated) based on the middle frequency (e.g., set point frequency) and stored. Thus, information Coarse_Count_1p and Coarse_Count_1n can be generated based on the number of cycles of the F_{REF} [0] signal within a sampling period (e.g., within one period of the CLK signal). Information Coarse_Count_2p and Coarse_Count_2n can be generated based on the number of cycles of the F_{FB} [0] signal within a sampling period (e.g., with one period of the CLK signal).

Fine count logic 320-1 can generate information Fine_Count_1 based on both the frequency and phase of the F_{REF} [0:n] signals. Fine count logic 320-1, multiplier 318-1, and adder 319-1 are arranged to generate information Full_Count_1. An input M provided to multiplier 318-1 has a value equal to the number of phases (M phases) of the F_{REF} [0:n] signals. For example, if the number of stages of oscillator 221 (FIG. 2) is five (e.g., M=5), then fine count logic 320-1 (FIG. 3) can generate information Full_Count_1 based on the frequency of five phases of the F_{REF} [0:n] signals.

Fine count logic 320-2 can generate Fine_Count_2 based on both the frequency and phase of the F_{REF} [0:n] signals. Fine count logic 320-2, multiplier 318-2, and adder 319-2 are arranged to generate information Full_Count_2. Input M provided to multiplier 318-2 has a value equal to the number of phases (M phases) of the F_{FB} [0:n] signals, which is the same as the number of phases of the F_{REF} [0:n] signals.

As described above with reference to FIG. 2, information Coarse_Count_1p and Coarse_Count_2p can be used to generate Coarse_Code_p. Information Coarse_Count_1n and Coarse_Count_2n can be used to generate Coarse_Code_n. Since the value of each of information Coarse_Count_1p and Coarse_Count_2p can be updated at every rising edge of the CLK signal, the value of Coarse_Code_p can also be updated at every rising edge of the CLK signal. Since the value of each of information Coarse_Count_1n and Coarse_Count_2n can be updated at every falling edge of the CLK signal, the value Coarse_Code_n can also be updated at every falling edge of the CLK signal. Thus, the value of information Coarse_Code_p and Coarse_Code_n (which are part of the error correction information) can be updated at consecutive edges (e.g., consecutive rising and falling edges) of the clock signal. For example, at a particular rising edge of the CLK signal, the value of information Coarse_Code_p can be updated. Then, at a falling edge immediately following that particular rising edge, the value of information Coarse_Code_n can be updated.

Information Full_Count_1 and Full_Count_2 can be used to generate information Error_Code. In the example shown in FIG. 2 and FIG. 3, if the number of phases of the F_{REF} [0:n] signal is five and the number of phases of the F_{FB} [0:n] signals is five (e.g., M=5), then the value of information Coarse_Code_p is five times less than the value of information Error_Code.

The dual-edge (rising and falling edge) error detection and update, as described herein, may reduce the non-linear response delay of voltage controller 110 to one-half of the period of the sampling clock (e.g., CLK) signal in worse case scenarios. This may result in the value of the droop in voltage V_{OUT} to be reduced to one-half, for example, of the value of a droop in some conventional schemes.

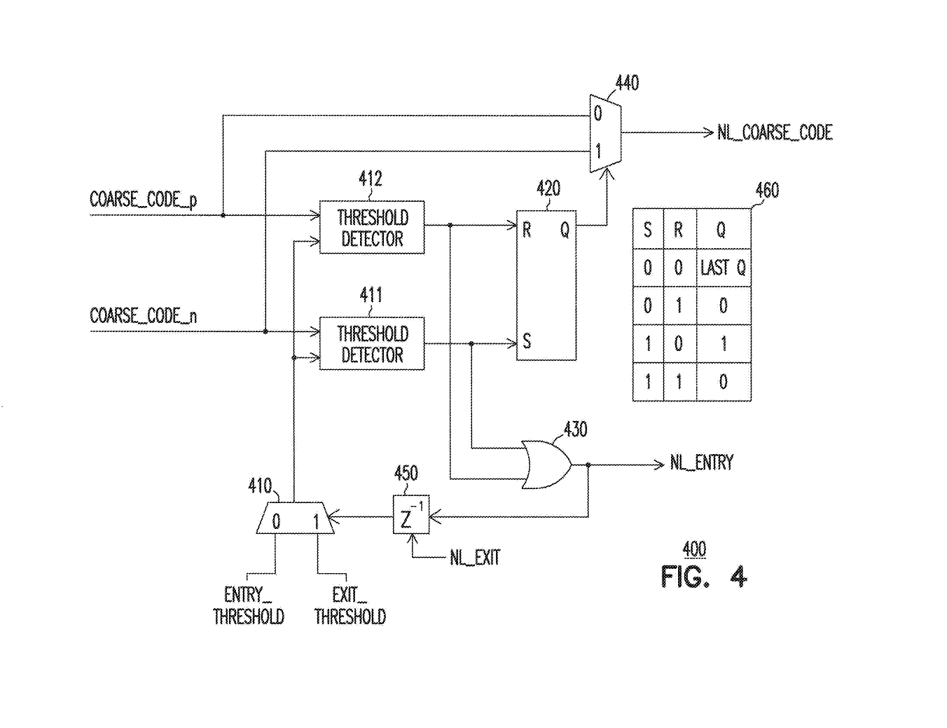

FIG. 4 shows a non-linear entry decision logic 400, according to some embodiments described herein. Non-linear entry decision logic 400 can be part of non-linear control code generator 130 (FIG. 1) or can be separated from non-linear control code generator 130. As shown in FIG. 4, non-linear entry decision logic 400 can include a selector 410 (e.g., a multiplexer), threshold detectors 411 and 412, a latch 420, a logic gate (e.g., OR logic gate) 430, a selector 440, and a delay element 450.

As described above with reference FIG. 1, voltage controller 110 can operate in linear and non-linear modes. In FIG. 4, non-linear entry decision logic 400 can operate to generate a signal NL_Entry (non-linear entry signal). Voltage controller 110 (FIG. 1) can enter or exit the non-linear mode based on the value (e.g., signal level) of the NL_Entry signal. For example, voltage controller 110 can enter the non-linear mode if the NL_Entry signal has one value (e.g., a low level corresponding to logic one) and exit the non-linear mode if the NL_Entry signal has another value (e.g., a high level corresponding to logic zero).

The value of the NL_Entry signal is based on the values information Coarse_Code_p and Coarse_Code_n (generated by error correction information generator 120 (FIG. 2) and based on information Entry_Threshold and Exit_Threshold. Information Entry_Threshold is digital information and can be set (e.g., pre-set) at a value (e.g., predetermined digital value). The value (digital value) of information Entry_Threshold can be set to be corresponding to a voltage value (e.g., 25 mV) at which voltage controller 110 enters the non-linear mode if an error (e.g., a droop) in voltage V_{OUT} has a value greater than that voltage value (e.g., greater than 25 mV). The value (digital value) of information Exit_Threshold can be set (e.g., pre-set) at a value (e.g., predetermined digital value). The value (digital value) of information Exit_Threshold can be set to be corresponding to a voltage value (e.g., 12.5 mV) at which voltage controller 110 exits the non-linear mode (and enters or returns to the linear mode) if an error (e.g., a droop) in V_{OUT} has a value less than that voltage value (e.g., less than 12.5 mV).

As an example, if the value of information Coarse_Code_p and Coarse_Code_n of one (Coarse_Code_p=Coarse_Code_n=1) corresponds to 12.5 mV error in voltage V_{OUT}, then a voltage in steps of 12.5 mV can be set (e.g., programmed). Thus, in this example, if the value of information Entry_Threshold is set at two (e.g., Entry_Threshold=2), which corresponds to 25 mV, then voltage controller 110 can enter the non-linear mode if an error (e.g., a droop) in voltage V_{OUT} has a value greater than 25 mV. In this example, if the value of information Exit_Threshold is set at one (e.g., Exit_Threshold=1), which corresponds to 12.5 mV, voltage controller 110 can exit the non-linear mode (and enter the linear mode) when the error (e.g., a droop) in voltage V_{OUT} (e.g., after a correction) is reduced from a value greater than 30 mV to a value less than 12.5 mV.

In FIG. 4, selector 410, threshold detectors 411 and 412, logic gate 430, and delay element 450 can operate to control the value of the NL_Entry signal. For example, if the values of both information Coarse_Code_p and Coarse_Code_n are less than the value of Entry_Threshold, the outputs of both threshold detectors 411 and 412 are at logic zero (e.g., low). The value of the NL_Entry signal is at logic zero. Selector 410 selects (or keeps selecting) information Entry_Threshold and provides it to threshold detectors 411 and 412. Voltage controller 110 does not enter the non-linear mode (e.g., remains in the linear mode) as long as the values of both information Coarse_Code_p and Coarse_Code_n are less than the value of Entry_Threshold.

When the value of either information Coarse_Code_p or Coarse_Code_n crosses (e.g., is greater than) the value of information Entry_Threshold, the output of one of threshold detectors 411 and 412 changes from logic zero to logic one (e.g., high). The value of the NL_Entry signal is changed from logic zero to logic one. Selector 410 deselects information Entry_Threshold and selects information Exit_Threshold and provides it to threshold detectors 411 and 412. Voltage controller 110 enters the non-linear mode (in response to the NL_Entry signal being at logic one) and stays in the non-linear mode as long as the values of at least one of information Coarse_Code_p and Coarse_Code_n is greater than the value of Exit_Threshold.

Voltage controller 110 can exit the non-linear mode when the values of both information Coarse_Code_p and Coarse_Code_n are less than the value of information Exit_Threshold. When this happens, the outputs of both threshold detectors 411 and 412 are zero (e.g., logic zero). The value of the NL_Entry signal is changed from logic one to logic zero. Selector 410 deselects information Exit_Threshold and selects (or re-selects) information Entry_Threshold and provides it to threshold detectors 411 and 412. Entering the linear mode can be repeated, as described above, based on the values of information Coarse_Code_p, Coarse_Code_n, Entry_Threshold, and Exit_Threshold.

In FIG. 4, information NL_Coarse_Code represents either information Coarse_Code_p or Coarse_Code_n, depending on the value of which of information Coarse_Code_p and the Coarse_Code_n that crosses (e.g., having a greater value than) the value of information Entry_Threshold and causes the activation of the NL_Entry signal. For example, the value of information Coarse_Code_p can be selected to be the value of NL_Coarse_Code if the value of information Coarse_Code_p crosses (e.g., has a greater value than) the value of information Entry_Threshold. In another example, the value of information Coarse_Code_n can be selected to be the value of information NL_Coarse_Code if the value of information Coarse_Code_n crosses (e.g., has a greater value than) the value of information Entry_Threshold.

Threshold detectors 411 and 412, latch 420, and selector 440 can operate such that the selection of information Coarse_Code_p and Coarse_Code_n can be based on a truth table 460 shown in FIG. 4. For example, if the value of Coarse_Code_p is determined to be greater than the value of information Entry_Threshold, latch 420 is reset and output Q goes to 0 (logic zero). Selector 440 selects information Coarse_Code_p to be information NL_Coarse_Code. In another example, if the value of Coarse_Code_n is determined to be greater than the value of information Entry_Threshold, latch 420 is set and output Q goes to 1 (logic one). Selector 440 selects Coarse_Code_n to be information NL_Coarse_Code.

In the above description, the value of information Exit_Threshold can be the same as or different from the value of information Entry_Threshold. However, setting the value of information Exit_Threshold to be less than the value of information Entry_Threshold may add some hysteresis while voltage controller 110 enters and exits the non-linear mode. This may improve the settling time of voltage V_{OUT}. Further, using error correction information (e.g., Coarse_Code_p and Coarse_Code_n) that are updated at every one-half period of the CLK signal may allow a relatively fast entry into the non-linear mode. Exiting the non-linear mode can also be controlled, such as by setting the value for information Exit_Threshold. Thus recovery of voltage V_{OUT} in the non-linear mode can be improved.

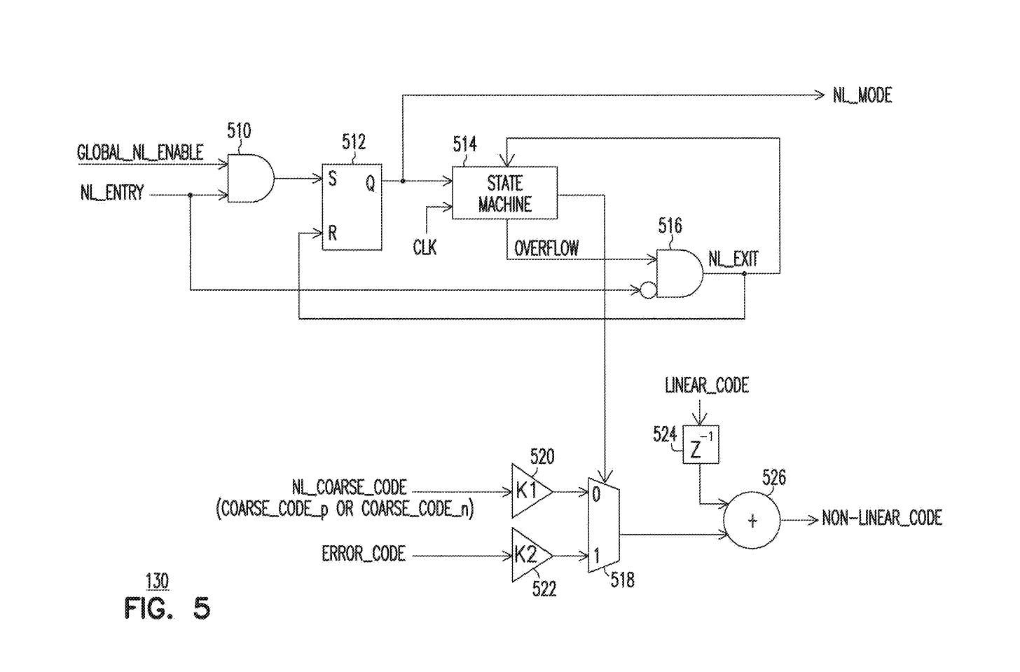

FIG. 5 shows a block diagram of non-linear control code generator 130 of FIG. 1, according to some embodiments described herein. As shown in FIG. 5, non-linear control code generator 130 receives the NL_Entry signal (generated by non-linear entry decision logic 400 of FIG. 4), and generates the NL_Mode signal (which is used to control selector 150 of FIG. 1) and information Non-Linear_Code (which is used to correct an error in V_{OUT} in the non-linear mode).

Non-linear control code generator 130 of FIG. 5 can also receive a signal Global_NL_Enable signal to allow an option of disabling (e.g., bypassing) non-linear control code generator 130 in the non-linear mode. For example, the Global_NL_Enable signal can be deactivated (provided with logic zero) during a debug operation in order to bypass the operation of non-linear control code generator 130 when the NL_Entry signal is activated. Bypassing the non-linear control code generator 130 (e.g., disabling the non-linear mode) in this example may be useful for comparing the behavior (e.g., the change in values) of voltage V_{OUT} with and without the inclusion of the operation of non-linear control code generator 130 when an error in voltage V_{OUT} occurs (e.g., during a load transient event). In a normal operation (e.g., a non-debug operation) of voltage controller 110, the Global_NL_Enable signal can be activated (provided with logic one) to allow enabling of the operation of non-linear control code generator 130 (e.g., when the NL_Entry signal is activated).

As shown in FIG. 5, non-linear control code generator 130 can include a logic gate (e.g., AND logic gate) 510, a latch 512, a state machine (e.g., finite state machine) 514, a logic gate (e.g., AND logic gate) 516, a selector (e.g., a multiplexer) 518, scaling components 520 and 522, a delay element 524, and an adder 526.

In operation, logic gate 510 and latch 512 can operate such that when the NL_Entry signal is activated (e.g., having logic one), the NL_Mode signal is activated (having logic one). This causes selector 150 (FIG. 1) to select information Non-Linear_Code to be information Control_Code to control power switching unit 112. State machine 514 can include two states: a state 0 and a state 1 in the non-linear mode. When the the NL_Entry signal is activated, state machine 514 can change (e.g., toggle) between state 0 and state 1 at the rising edge of the CLK signal clock. State machine 514 can toggle between states 0 and 1 until voltage controller 110 exits the non-linear mode.

State machine 514 and selector 518 can operate, such that during state 0, selector 518 selects information NL_Coarse_Code (which is either Coarse_Code_p or Coarse_Code_n) for the calculation of information Non-Linear_Code during state 0 of state machine 514. For example, if the value of information Coarse_Code_p is greater than the value of information Entry_Threshold (that cause the activation of the NL_Entry signal), then the value of information Coarse_Code_p can be selected to be the value of NL_Coarse_Code. If the value of information Coarse_Code_n is greater than the value of information Entry_Threshold (that cause the activation of the NL_Entry signal), then the value of information Coarse_Code_n can be selected to be the value of NL_Coarse_Code. During state 1, selector 518 selects information Error_Code for the calculation of information Non-Linear_Code.

After entering the non-linear mode, voltage controller 110 may remain in the non-linear mode for 1.5 cycles, 2 cycles, or greater than 2 cycles of the CLK signal depending on whether the NL_Entry signal is activated at the rising or falling edge of the CLK signal. For example, if the NL_Entry signal is activated at the falling edge of the CLK signal (e.g., based on Coarse_Code_n), then voltage controller 110 may remain in the non-linear mode for at least 1.5 cycles of the CLK signal because it only takes state machine 514 one-half cycle of the CLK signal from the activation of the NL_Entry signal to the next rising edge of the CLK signal to change its state from state 0 to state 1. In another example, if the NL_Entry signal is activated at the rising edge of the CLK signal (e.g., based on Coarse_Code_p), then voltage controller 110 may remain in the non-linear mode for at least 2 cycles of the CLK signal because it takes state machine 514 a full cycle of the CLK signal from the activation of the NL_Entry signal to the next rising edge of the CLK signal to change its state from state 0 to state 1.

During state 0 (e.g., initial state) of state machine 514, the value of information NL_Coarse_Code can be multiplied by a scaling factor K1 and added to the previous value of information Control_Code in order obtain an initial value for information Non-Linear_Code after entering the non-linear mode (after the NL_Entry is activated). The previous value of information Control_Code is based on the value of information Linear_Code generated by linear control code generator 140 before entering the non-linear mode (before the NL_Entry signal is activated). The initial value for information Non-Linear_Code is selected by selector 150 (FIG. 1) to be used as the value of information Control_Code.

The value of scaling factor K1 in FIG. 5 can be selected based on the value of output load capacitance (e.g., the value capacitor 160 in FIG. 1), current resolution of the power-FET bank (e.g., power switching unit 112) coupled to nodes 101 and 102 (FIG. 1), and ADC sampling clock period (e.g., the period of the CLK signal). Depending on the ADC resolution, the value of the error coarse count can vary. The value of scaling factor K1 can be selected such that the value of the first step of information Control_Code (e.g., the step right after the NL_Entry signal is activated) can prevent the value of voltage V_{OUT} from decreasing (e.g., drooping) further and allow it to recover as close as possible with respect to the current load. For example, if the value of output load capacitance is 25 nF and effective sampling clock period is 1.25 ns (due to sampling every half-cycle) and current resolution of power switching unit 160 is 4 mA, then the value of scaling factor K1 can be 64, for example. In this example, for load step of 2 A/ns (e.g., worst case load step), the value of information Coarse_Code_p or Coarse_Code_n can be 5, which would result in the value of the first step of information Control_Code of 5*K1=5*64=320. For a load step of 2 A/10 ns, when the value of information Coarse_Code_p or Coarse_Code_n reaches 2 (e.g., Entry_Threshold), the value of the first step of information Control_Code is 2*K1=2*64=128. Thus, the value of the step of information Control_Code is adaptive to the rate of load step. For ease of implementation (e.g., for quick and easy computation), the value of scaling factor K1 can be selected to be a number power of 2.

The scheme described herein can adaptively determine (e.g., automatically adjust) the rate of recovery of voltage V_{OUT} in the non-linear mode based on (e.g., proportional to) the type of load step. For example, if the load step (e.g., di/dt rate during load transient event) has a relatively large slew-rate (e.g., load step of 2 A/ns) and the output voltage error in voltage V_{OUT} is detected to be relatively large (e.g., 100 mV for specified 1V V_{OUT}), then the value of information Control_Code during the non-linear mode (which is based on Non-Linear_Code) can be relatively large. If the load step is relatively small (e.g., 2 A/10 ns), then the value of information Control_Code can be relatively small. Thus, in state 0, the amount used to adjust the value of information Control_Code in the non-linear mode is proportional to the value information Coarse_Code_p or Coarse_Code_p (error correction information).

During state 1 of the state machine 514, selector 518 selects information Error_Code for the calculation of information Non-Linear_Code. The value of information Error_Code can be multiplied by a scaling factor K2 and added to the value of Non-Linear_Code calculated in the previous cycle. The value of scaling factor K2 in FIG. 5 can be selected in fashion similar to that of scaling factor K1. For example, the value of scaling factor K2 can be selected based on output load capacitance, current resolution of the power-FETs, and ADC sampling clock period. For ease of implementation (e.g., for quick and easy computation), the value of scaling factor K2 can also be selected to be a number power of 2. The difference between the values of scaling factors K1 and K2 is that K2 is multiplied by the actual error code (e.g., Error_Code) that has a resolution 5 times greater than the resolution the coarse error code (e.g., Coarse_Code_p and Coarse_Code). Thus, the value of scaling factor K2 can be 5 times less than the value of scaling factor K1. For example, if the value of scaling factor K1 is 64 (e.g., K1=64), then value of scaling factor K2 can be close to one-fifth of the value of scaling factor K1 using similar approach as scaling factor K1 and still be a power of 2. Thus, in the example of K1=64, the value of scaling factor K2 can be selected to be 8, which is close to one-fifth of 64 and still be a number of power of 2. A lower value of scaling factor K2 may also ensure smooth recovery and prevent large over-shoots during recovery. During state 1, if the error in voltage V_{OUT} is still large (after the error correction done in state 0), then the value of information Control_Code can be incremented by a larger value. If the error in voltage V_{OUT} is small, then the value of information Control_Code can be incremented by a smaller value. If the error in voltage V_{OUT} is deemed to be negative, then the value of information Control_Code can be decremented by a certain value. Thus, in state 1, the amount used to adjust the value of information Control_Code in the non-linear mode is proportional to the value of information Error code (error correction information). Providing the value for information Control_Code during states 0 and 1, as described herein, may help in a faster settling in the value of voltage V_{OUT} during the non-linear mode. It may also avoid improper operation if a false activation of the non-linear mode happens.

Thus, as described herein, the step (e.g., amount of increment) in information Control_Code in the non-linear mode (which is based on Non-Linear_Code) may not be a fixed value and may be proportionally adjusted based on value of the error in voltage V_{OUT}. Therefore, over-shoots or under-shoots in the value of voltage V_{OUT} may be avoided. For comparison purposes, some conventional schemes may use a fixed step for the control information (e.g., Control_Code) that may result in over-shoots, or multiple larger droops, or both.

In FIG. 5, after every 1.5 cycles (if the non-linear mode is entered based on information Coarse_Code_n) or 2 cycles (if the non-linear mode is entered based on information Coarse_Code_p) of the CLK signal in the non-linear mode, if the values of voltage V_{OUT} (FIG. 1) and both information Coarse_Code_p and Coarse_Code_n (FIG. 4) have recovered within the value of information Exit_Threshold (e.g., less than the value of Exit_Threshold), then the NL_Entry signal (FIG. 4) is deactivated (e.g., having logic zero). Logic gate 516 in FIG. 5 can operate such that when the NL_Entry signal is deactivated and the state counter overflows, the NL_EXIT signal is activated (e.g., having logic one). This causes voltage controller 110 to exit the non-linear mode and enter the linear mode. State machine 514 can be reset when the NL_EXIT signal is activated. If voltage V_{OUT} has not fully recovered (the NL_EXIT signal is not activated), then voltage controller 110 can continue to be in the non-linear mode for another 2 clock cycles.

As long as voltage controller 110 is in the non-linear mode, the value of information Control_Code (which is used to control power switching unit 112 in FIG. 1) is still based on the values of information NL_Coarse_Code and Error_Code during state 0 and state 1, respectively, of state machine 514. This makes the time that voltage controller 110 spends in the non-linear mode adaptive to (e.g., proportional to) the time that the load current takes to ramp from an initial value (e.g., when a droop in voltage V_{OUT} occurs) to a final value. In some cases, voltage controller 110 may exit the non-linear mode in the next 2 to 3 cycles of the CLK signal after the current ramp is completed. This time (e.g., 2 to 3 cycles) helps voltage V_{OUT} to recover almost completely and much faster relative to that of the linear mode. Thus, in the scheme described herein, voltage controller 110 may spend less time in the non-linear mode during fast ramps (e.g., ramps of 2 A/ns) and more time in the non-linear during slow ramps (e.g., ramps of 2 A/10 ns) to allow voltage V_{OUT} to almost fully recover and safely enter the linear mode before the non-linear to linear switch-over happens.

FIG. 6 shows a block diagram of a linear control code generator 140 of FIG. 1, according to some embodiments described herein. As shown in FIG. 6, linear control code generator 140 can include delay elements 610 and multipliers 612 (associated with coefficients b0, b1, and b2) arranged to receive information Error_Code. Linear control code generator 140 can also include delay elements 620 and multipliers 622 (associated with coefficients a0 and a1) arranged to receive information Control_Code. Linear control code generator 140 can generate information Linear_Code based on the combination of information Error_Code and information Control_Code.

The arrangement of linear control code generator 140 as shown in FIG. 6 allows the value of information Non-Linear_Code (generated by non-linear control code generator 130 in FIG. 5) during the non-linear mode to be written back to linear control code generator 140 (as also mentioned above with reference to the description of FIG. 1). This non-linear write back allows the value of information Linear_Code of linear control code generator 140 to quickly catch up with the value of information Non-Linear_Code when voltage controller 110 exits the non-linear mode. Thus, the value of information Linear_Code in the current cycle can be equal to or greater than the value of information Non-Linear_Code in the previous cycle. Therefore, when linear control code generator 140 takes control, it starts from where non-linear control code generator 130 left off. For example, when voltage controller 110 changes from the non-linear mode to the linear mode, linear control code generator 140 can provide information Linear_Code having a value at least equal to the value of information Control_Code in the previous non-linear mode. The non-linear write-back, as described herein, may prevent a sudden jump in the value of information Control_Code. This may improve the stability in the value of voltage V_{OUT}.

For example, linear control code generator 140 shown in FIG. 6 can operate such that the value of information Linear_Code in the current cycle can be a combination (e.g., a sum) of the value of information Control_Code in the previous cycle (e.g., in the previous non-linear mode) and an amount corresponding to the value of information Error_Code in the current cycle. Thus, in this example, if the value of information Error_Code in the current cycle is deemed to be zero, then the value of information Linear_Code in the current cycle is equal to the value of information Control_Code in the previous cycle. If the value of information Error_Code in the current cycle is greater than zero, then the value of information Linear_Code in the current cycle is greater than the value of information Control_Code in the previous cycle.

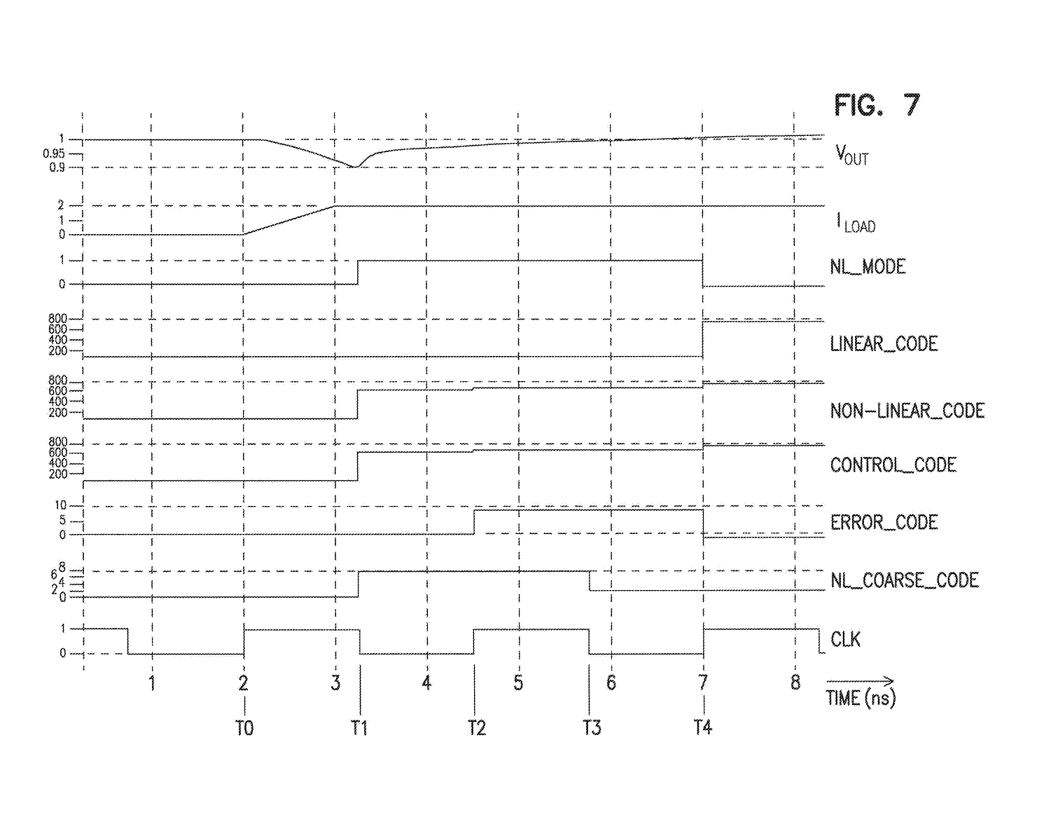

FIG. 7 shows an example timing diagram for some of the error correction information and signals associated with an operation of voltage controller 110 of FIG. 1 through FIG. 6 in response to load step having a relatively large value, according to some embodiments described herein. The timing diagram in FIG. 7 is based on an example response of voltage controller 110 for current I_{LOAD} having a load step of 2 A/ns and capacitor 160 having example value of 24 nF. In the example associated with FIG. 7, the target value of voltage V_{OUT} is 1V. The value of information Entry_Threshold is set (e.g., pre-set) at Entry_Threshold=2 that corresponds to a voltage value of 25 mV. This means that, in this example, voltage controller 110 enters the linear mode if the error in voltage V_{OUT} has a value greater than 25 mV.

At time T0 (rising edge of the CLK signal), an error (e.g., a droop) in voltage V_{OUT} starts to occur. At time T1, the value of the error is approximately 100 mV (which means that the value of voltage V_{OUT} is reduced from its target value (e.g., 1V) by approximately 100 mV).

At time T1 (falling edge of the CLK signal), since the error in voltage V_{OUT} has a value (e.g., 100 mV) greater than 25 mV (the voltage value corresponding to the value of the information Entry_Threshold), the NL_Mode signal changes from 0V (e.g., low) to 1V (e.g., high). This causes voltage controller 110 to enter the non-linear mode at time T1 and to start correcting the error.

The time interval between times T0 and T1 is equal to one-half of the period (e.g., sampling period) of the CLK signal. Thus, in the example of FIG. 7, voltage controller 110 enters the linear mode (e.g., at time T1 at the falling edge of the CLK signal) within one-half period of the CLK signal from the time (e.g., sometime between times T0 and T1) that the error has a value greater than the pre-set value of information Entry_Threshold.

Between times T1 and T4, voltage controller 110 performs the error correction, such as the coarse tuning correction and fine tuning correction, as described above with reference to FIG. 1 through FIG. 6, in order to reduce the error so that the value of voltage V_{OUT} can return to its target value (e.g., 1V).

At time T4, NL_Mode signal changes from 1V to 0V, indicating that the error has a value less than a value corresponding to the value of information Exit_Threshold (FIG. 4). This causes voltage controller 110 to exit the non-linear mode (and enters the linear mode) at time T4. As shown in FIG. 7, the settling of voltage V_{OUT} from time T1 to time T4 (e.g., settling time of approximately 4 ns) is relatively smooth.

In FIG. 7, information Linear_Code, Non-Linear_Code, Control_Code, Error_Code, NL_Coarse_Code, and the CLK signal can have values based on the operation of voltage controller 110 described above with reference to FIG. 1 through FIG. 6.

The operation to correct error (e.g., a droop) in voltage V_{OUT} in the non-linear mode of voltage controller 110, as shown in FIG. 7, may have an improvement over some conventional schemes. For example, some conventional schemes may take a full cycle of a sampling clock signal to update the value of an error (e.g., a first droop) voltage V_{OUT}. Thus, such an error in some conventional schemes may have a value (e.g., 200 mV) greater than the value (e.g., 100 mV) of the error of voltage controller 110 by the time the error is detected in the conventional schemes. This may cause the conventional schemes to spend more time on the error correction operation relative to that of voltage controller 110. Further, a greater value of the error in conventional schemes may reduce the stability voltage V_{OUT} when the error occurs.

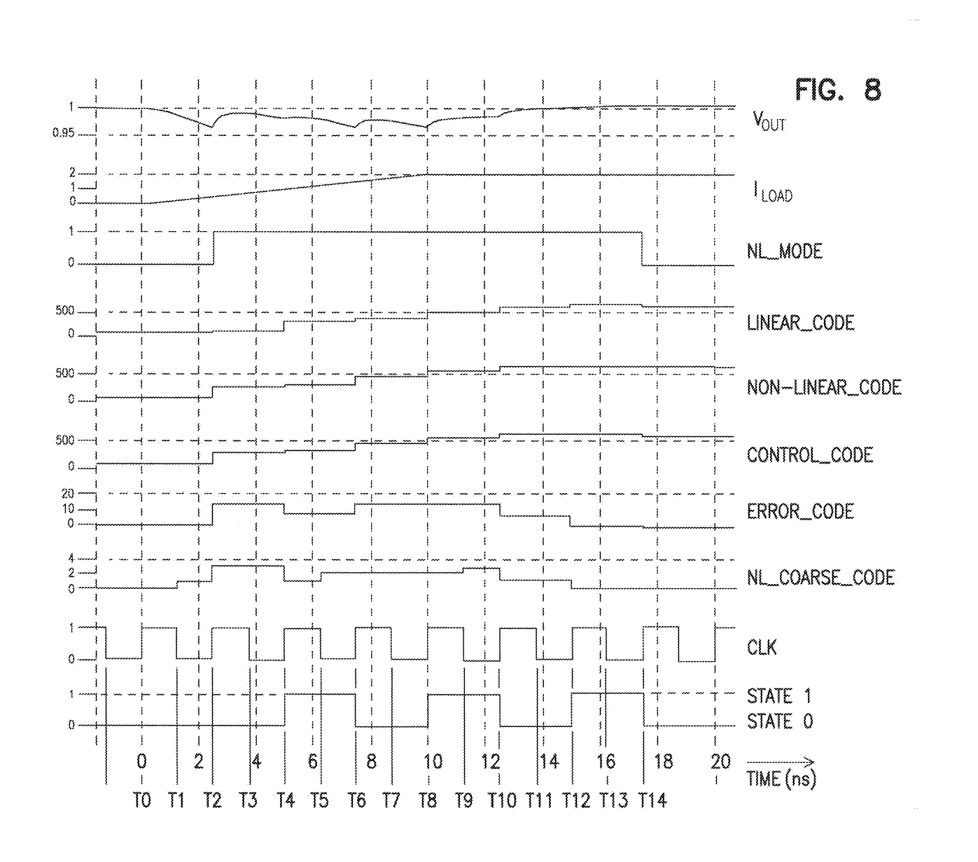

FIG. 8 shows another example timing diagram for some of the error correction information and signals associated with an operation of voltage controller 110 of FIG. 1 through FIG. 6 in response to load step having a relatively small value, according to some embodiments described herein. The timing diagram in FIG. 8 is based on an example response of voltage controller 110 for current I_{LOAD} having an example load step of 2 A/10 ns and capacitor 160 having an example value of 24 nF. In the example associated with FIG. 8, the target value of voltage V_{OUT} is 1V. Similar to the example of FIG. 7, the value of information Entry_Threshold in FIG. 8 is set (e.g., pre-set) at Entry_Threshold=2, which corresponds to 25 mV. This means that, in this example, voltage controller 110 enters the linear mode if the error in voltage V_{OUT} has a value greater than 25 mV.

At time T0 (rising edge of the CLK signal), an error (e.g., a droop) in voltage V_{OUT} starts to occur. At time T1, the error may have a value not greater than the pre-set threshold value of 25 mV. Thus, as shown in FIG. 8 at time T1, the NL_Mode signal remains at 0V (e.g., low).

At time T2, the value of the error is approximately 30 mV (which means that the value of voltage V_{OUT} is reduced from its target value by approximately 30 mV).

At time T2 (rising edge of the CLK signal), since the value (35 mV) of the error in voltage V_{OUT} has a value greater than 25 mV (the voltage value corresponding to the value of the information Entry_Threshold), the NL_Mode signal changes from 0V (e.g., low) to 1V (e.g., high). This causes voltage controller 110 to enter the non-linear mode at time T2 and to start to correct the error.

Between times T3 and T14, voltage controller 110 performs the error correction, such as the coarse tuning correction and fine tuning correction, as described above with reference to FIG. 1 through FIG. 6, in order to reduce the error so that the value of voltage V_{OUT} can return to its target value (e.g., 1V).

At time T14, the NL_Mode signal changes from 1V to 0V, indicating that the error has a value less than a value corresponding to the value of information Exit_Threshold. This causes voltage controller 110 to exit the non-linear mode (and enter the linear mode) at time T14.

As shown in FIG. 8, the settling time of voltage V_{OUT} (e.g., from time T2 to time T14) is approximately 15 ns, which is proportional to the ramp time of the load step.

The value of information Non-Linear_Code (which is information Control_Code in the linear mode) between times T1 and T14 is updated with variable increments (e.g., variable steps) at each rising edge of the CLK signal (e.g., between times T2 and T14). The value of information Non-Linear_Code between times T1 and T4 is also changed by an amount proportional to the current load step (e.g., a ratio of current over time (di/dt) between times T0 and T7). These dynamical variable increments match the rate and amount of increase in I_{LOAD} in different cycles of the CLK signal. The variable increments in the value of information Non-Linear_Code may prevent over-shoot in voltage V_{OUT} during recovery (e.g., prevent over-shoot in voltage V_{OUT} between times T2 and T14).

In FIG. 8, information Linear_Code, Non-Linear_Code, Control_Code, Error_Code, NL_Coarse_Code, the CLK signal, and the states (e.g., states 0 and 1) can have values based on the operation of voltage controller 110 described above with reference to FIG. 1 through FIG. 6.

The operation to correct error (e.g., a droop) in voltage in V_{OUT} the non-linear mode of voltage controller 110 may have an improvement over some conventional schemes. For example, some conventional schemes may use fixed increments to correct the error. Such fixed increments may cause over-shoots in the output voltage during recovery and may cause a slower recovery (e.g., a larger settling time).

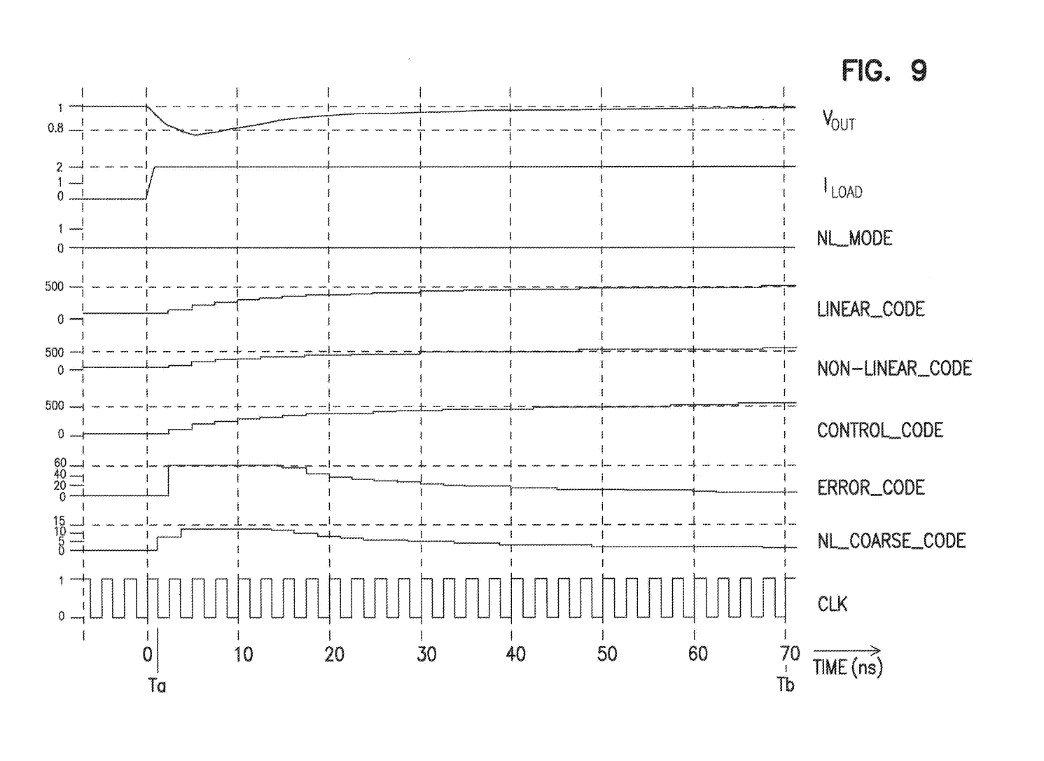

FIG. 9 shows an example timing diagram for some of the error correction information and signals associated with an operation of voltage controller 110 of FIG. 1 through FIG. 6 when the error correction operation in the non-linear mode is disabled, according to some embodiments described herein. Similar to that of FIG. 7, The timing diagram in FIG. 9 is based on an example response of voltage controller 110 for current I_{LOAD} having a load step of 2 A/ns and capacitor 160 having an example value of 24 nF. In the example associated with FIG. 9, the target value of voltage V_{OUT} is 1V.

In the example associated with FIG. 9, since the non-linear mode is disabled, voltage controller 110 remains in the linear mode. As shown in FIG. 9, at time TA, an error (e.g., a droop) in voltage V_{OUT} starts to occur.

The value of the error can be relatively large (approximately 250 mV) in comparison with the value of the error (e.g., 100 mV) shown in FIG. 7. The recovery time (e.g., from time Ta to time Tb) of voltage V_{OUT} is also relatively large (e.g., approximately 70 ns) in comparison with the recovery time (e.g., 4 ns) shown in FIG. 7. Thus, the inclusion of the error correction operation in the non-linear mode in a voltage controller (e.g., voltage controller 110) as described above with reference to FIG. 1 through FIG. 8 may improve the performance of the voltage controller, such as by preventing a large droop and improving in dynamic response.

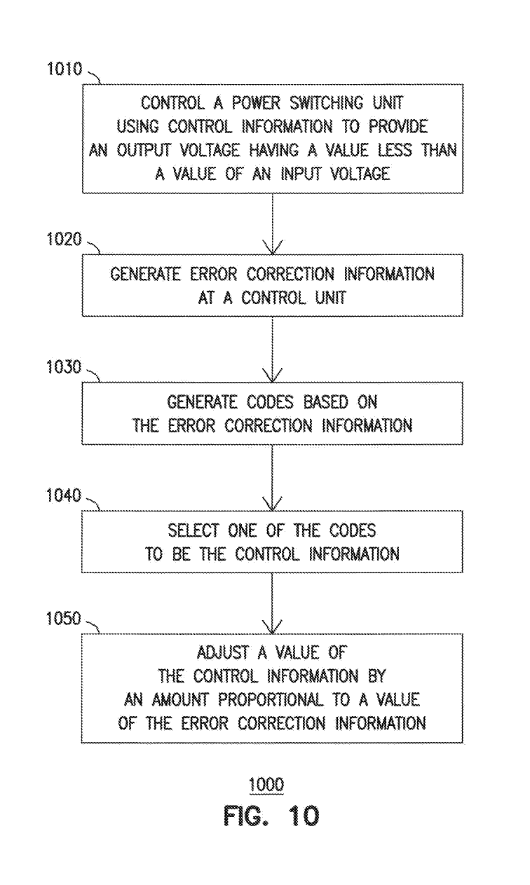

FIG. 10 is a flow diagram showing a method 1000 of controlling a voltage, according to some embodiments described herein. Method 1000 can be performed by an apparatus, such as apparatus 100 of FIG. 1 including voltage controller 110 described above with reference to FIG. 1 through FIG. 8. Method 1000 can control (e.g., regulate) a voltage, such as voltage V_{OUT} described above with reference to FIG. 1 through FIG. 9.

As shown in FIG. 10, method 1000 can include activities 1010, 1020, 1030, 1040, and 1050. Activity 1010 can include controlling a power switching unit using control information (e.g., Control_Code) to provide an output voltage (e.g., V_{OUT}) having a value less than a value of an input voltage (e.g., V_{IN}).

Activity 1020 can include generating error correction information (e.g., Error_Code, Coarse_Code_p, and Coarse_Code_n) at a control unit. The value of the error correction information can be based on a value of an error in the output voltage.

Activity 1030 can include generating codes (e.g., Linear_Code and non-Linear_Code) based on the error correction information.

Activity 1040 can include selecting one of the codes to be the control information in a mode (e.g., linear or non-linear) of the control unit. The Selection of the codes in activity 1040 can be based on a value of a threshold information. For example, activity 1040 can include selecting one code (e.g., Linear_Code) to be the control information in one mode (e.g., linear mode) of the control unit if the error has a value less than the value of a threshold information. In another example, activity 1020 can include selecting another code (e.g., Non-Linear_Code) to be the control information in another mode (e.g., non-linear mode) of the control unit if the error has a value greater than the value of the threshold information.

Activity 1050 can include adjusting a value of the control information (e.g., while in linear or non-linear mode) by an amount proportional to a value of the error correction information. The adjustment in activity 1050 may allow the value of the output voltage to recover to a target value.

Method 1000 can include additional activities (e.g., operations) of voltage controller 110 described above with reference to FIG. 1 through FIG. 9.

In the schemes described above with reference to FIG. 1 through FIG. 10, over-shoots, under-shoots, or both, in voltage V_{OUT} may be avoided due to the adaptive step scheme in the control information (e.g., Control_Code). The settling of voltage V_{OUT} may also be relatively fast due to the adaptive step scheme and to the 1.5 or 2 cycle approach. Exiting the non-linear mode, as described above, may happen only when load ramp (associated with current I_{LOAD}) is completed and voltage V_{OUT} has almost recovered completely in the non-linear mode. The number of cycles in the non-linear mode can depend on (e.g., can be proportional to) the ramp time of the load step.

In the the non-linear mode, voltage controller 110 may constantly look at either the coarse error information (e.g., Coarse_Code) or full error information (e.g., Error_Code) to adjust the value of the control code (e.g., Control_Code) that controls the power switching unit 112 to adjust the size (e.g., number) of transistors to be turned on. This helps in reducing over-shoots, under-shoots, or both, during load transient events of different load conditions (e.g., different load steps).

In voltage controller 110, the value of the error (e.g., first droop) in voltage V_{OUT} may be reduced by one-half in comparison with some conventional schemes because the error correction information (e.g., Coarse_Code_p and Coarse_Code_n) is updated for both rising and falling edges (e.g., dual update) of the sampling clock signal (e.g., CLK signal) with a relatively low over-head power.

Moreover, since voltage controller 110 is digitally controlled, it can be portable from one technology node to another. Further, since voltage controller 110 can operate under different load conditions (e.g., different load steps), it may increase its modularity and re-usability. This may lead to savings in design time and cost. This may also be useful for processing unit type loads (e.g., central processing unit (CPU) type loads) which may have large load transient events. Such processing unit type loads (e.g., CPU type loads) may include turbo operating mode. Voltage controller 110 may help in entering and exiting such turbo operating mode quickly by keeping the output voltage (e.g., V_{OUT}) regulated at most of the times and under most load transient conditions. This may improve performance of processors and enrich user experience through fast response time.

The illustrations of apparatus (e.g., apparatus 100) and methods (e.g., method 1000, and the operations of voltage controller 110 described above with reference to FIG. 1 through FIG. 9) are intended to provide a general understanding of the structure of various embodiments and are not intended to provide a complete description of all the elements and features of apparatuses that might make use of the structures described herein.

The apparatus (e.g., apparatus 100) described herein may include or be included in electronic circuitry, such as high-speed computers, communication and signal processing circuitry, single or multi-processor modules, single or multiple embedded processors, multi-core processors, message information switches, and application-specific modules including multilayer, multi-chip modules. Such apparatuses may further be included as sub-components within a variety of other apparatuses (e.g., electronic systems), such as televisions, cellular telephones, personal computers (e.g., laptop computers, desktop computers, handheld computers, tablet computers, etc.), workstations, radios, video players, audio players (e.g., MP3 (Motion Picture Experts Group, Audio Layer 5) players), vehicles, medical devices (e.g., heart monitor, blood pressure monitor, etc.), set top boxes, and others.

### ADDITIONAL NOTES AND EXAMPLES

Example 1 includes subject matter (such as a device, apparatus, or machine) comprising a power switching unit to receive a first voltage and provide a second voltage, a control unit to generate control information to control the power switching unit such that a value of the second voltage is less than a value of the first voltage, generate error correction information having a value based on a value of an error in the second voltage, and operate in a first mode if the error has a value less than a value of a threshold information and in a second mode if the error has a value greater than the value of the threshold information, and adjust the value of the control information by an amount proportional to the value of the error correction information in the second mode.

In Example 2, the subject matter of Example 1 may optionally include, wherein the control unit is arranged to enter the second mode based on the value of the threshold information and exit the second mode based on a value of an additional threshold information.

In Example 3, the subject matter of Example 2 may optionally include, wherein the value of the additional threshold information and is less than the value of the threshold information.

In Example 4, the subject matter of Example 2 may optionally include, wherein the value of the additional threshold information and is equal to the value of the threshold information.

In Example 5, the subject matter of Example 2 may optionally include, wherein the control unit is arranged to receive a clock signal and enter the second mode at a rising edge of the clock signal if the value of the error is greater than the value of threshold information at the rising edge of the clock signal, and enter the second mode at a falling edge of the clock signal if the value of the error is greater than the value of threshold information at the falling edge of the clock signal

In Example 6, the subject matter of Example 2 may optionally include, wherein the power switching unit includes a node to provide the second voltage, and the control unit is arranged to cause the value of the control information to change by an amount proportional to a ratio of current overtime at the node.

In Example 7, the subject matter of Example 2 may optionally include, wherein the power switching unit includes a node to provide the second voltage, and the control unit is arranged to cause a settling time of the second voltage to be proportional to a ramp time of a current at the node.

In Example 8, the subject matter of Example 2 may optionally include, wherein the control unit is arranged to receive a clock signal and update the value of the error correction information at every one-half of a cycle of the clock signal.

In Example 9, the subject matter of Example 2 may optionally include, wherein the control unit is arranged to receive a clock signal and update the value of the error correction information at consecutive edges of the clock signal.

Example 10 includes subject matter (such as a device, apparatus, or machine) comprising a power switching unit to receive control information and an input voltage to provide an output voltage having a value less than a value of the input voltage, a signal generator to generate signals having a first frequency based on a reference voltage and a second frequency based on a feedback voltage generated from the output voltage, an error calculation logic block to generate a first error correction information and a second error correction information based on least on a difference between the first and second frequencies, the first error correction information having a value different from a value of the second error correction information, a first generator to generate a first code based on the first error correction information, a second generator to generate a second code based on the first and second error correction information, and a selector to select the first code to be the control information in a first mode and to select the second code to be the control information in a second mode.

In Example 11, the subject matter of Example 10 may optionally include, wherein the error calculation logic block is arranged to receive a clock signal and sample the signals at a sampling frequency based on a frequency of the clock signal to generate the first and second error correction information.

In Example 12, the subject matter of Example 11 may optionally include, wherein the error calculation logic block is arranged to update the value of the second error correction information at every one-half period of the clock.

In Example 13, the subject matter of Example 12 may optionally include, wherein the error calculation logic block includes a first time-to-digital converter to generate a first count based on a number of cycles of the first frequency between rising edges of a period of a clock signal, and a second count based on a number of the cycles of the first frequency between falling edges of a period of the clock signal, a second time-to-digital converter to generate a third count based on a number of the cycles of the second frequency between rising edges of the period of a clock signal, and a fourth count based on a number of the cycles of the second frequency between falling edges of the period of the clock signal, a calculator to generate a first coarse count based on a difference between the first and third counts, and a second coarse count based on a difference between the second and fourth counts, wherein the value of the second error correction information is based on one of the first and second coarse counts.

In Example 14, the subject matter of Example 12 may optionally include, wherein the signals includes first signals having the first frequency and second signals having the second frequency, and the error calculation logic block includes a first time-to-digital converter to generate a first full count based on the phases and frequency of the first signals, a second time-to-digital converter to generate a second full count based on the phases and frequency of the second signals, a calculator to calculate a difference between the first and second full counts to provide the value of the first error correction information.

In Example 15, the subject matter of Example 14 may optionally include, wherein the signal generator includes a first oscillator to generate the first signals based on a first current having a value based on a value of the reference voltage, and a second oscillator to generate the second signals based on a second current having a value based on a value of the feedback voltage.

In Example 16, the subject matter of Example 10 may optionally include, wherein the first generator is arranged to receive the first error correction information and the control information, such that a value of the first code is a combination of values from the first error correction information and the control information.

In Example 17, the subject matter of Example 10 may optionally include, wherein the second generator is arranged to receive the first error correction information, the second control information, and the first code, such that a value of the second code is a combination of values of the first code and a value of one of the first and second error correction information.

Example 18 includes subject matter (such as a device, apparatus, or machine) comprising a semiconductor die, a processing unit located on the semiconductor die, and a voltage controller located on the semiconductor die and coupled to the processing unit, the voltage controller including a power switching unit to receive an input voltage and provide an output voltage, and a control unit to generate control information to control the power switching unit such that a value of the output voltage is less than a value of the input voltage, generate error correction information having a value based on a value of an error in the second voltage, operate in a first mode if the error has a value less than a value of a threshold information and in a second mode if the error has a value greater than the value of the threshold information, and adjust the value of the control information by an amount proportional to the value of the error correction information in the second mode.

In Example 19, the subject matter of Example 18 may optionally include, wherein the first mode includes a linear mode, and the second mode includes a non-linear mode.

In Example 20, the subject matter of Example 18 may optionally include, wherein the power switching unit includes a node to provide the second voltage, and the voltage controller is arranged to enter the second mode during a load transient event occurring at the node.

In Example 21, the subject matter of Example 18 may optionally include, wherein the semiconductor die, the processing unit, and the voltage controller are parts of a system-on-chip (SoC).

Example 22 includes subject matter including a method of controlling a voltage, the method comprising receiving an input voltage at a power switching unit, controlling the power switching unit using control information to provide an output voltage having a value less than a value of the input voltage, generating error correction information at a control unit, such that a value of the error correction information is based on a value of an error in the output voltage, generating a first code and a second code based on the error correction information, selecting the first code to be the control information in a first mode of the control unit if the value of the error is less than a value of a threshold information, selecting the second code to be the control information in a second mode of the control unit if the value of the error is greater than the value of the threshold information, and adjusting a value of the control information in the first and second modes by an amount proportional to the value of the error correction information.

In Example 23, the subject matter of Example 22 may optionally include generating the error correction information includes generating first signals having a frequency based on a value of a reference voltage, generating second signals having a frequency based on a version of the output voltage, and generating the error correction information based on a difference in frequencies and phases between the first signals and the second signals.

In Example 24, the subject matter of Example 23 may optionally include generating the error correction information includes sampling the first signals and second signals at a sampling frequency based on a frequency of a clock signal to generate a first count based on the sampling of the first signals and a second count based on the sampling of the second signals, and calculating the value of the error correction information based on the first and second counts.

In Example 25, the subject matter of Example 24 may optionally include generating the error correction information includes updating the first and second counts at every one-half period of the clock signal.

The subject matter of Example 1 through Example 20 may be combined in any combination.

The above description and the drawings illustrate some embodiments to enable those skilled in the art to practice the embodiments of the invention. Other embodiments may incorporate structural, logical, electrical, process, and other changes. Examples merely typify possible variations. Portions and features of some embodiments may be included in, or substituted for, those of other embodiments. Many other embodiments will be apparent to those of skill in the art upon reading and understanding the above description. Therefore, the scope of various embodiments is determined by the appended claims, along with the full range of equivalents to which such claims are entitled.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus comprising:
a power switching unit to receive a first voltage and provide a second voltage; and
a control unit to:
generate control information to control the power switching unit such that a value of the second voltage is less than a value of the first voltage;
generate error correction information having a value based on a value of an error in the second voltage, and operate in a first mode if the error has a value less than a value of a threshold information and in a second mode if the error has a value greater than the value of the threshold information; and
adjust the value of the control information by an amount proportional to the value of the error correction information in the second mode.

2. The apparatus of claim 1, wherein the control unit is arranged to enter the second mode based on the value of the threshold information and exit the second mode based on a value of an additional threshold information.

3. The apparatus of claim 2, wherein the value of the additional threshold information and is less than the value of the threshold information.

4. The apparatus of claim 2, wherein the value of the additional threshold information and is equal to the value of the threshold information.

5. The apparatus of claim 1, wherein the control unit is arranged to receive a clock signal and enter the second mode at a rising edge of the clock signal if the value of the error is greater than the value of threshold information at the rising edge of the clock signal, and enter the second mode at a falling edge of the clock signal if the value of the error is greater than the value of threshold information at the falling edge of the clock signal.

6. The apparatus of claim 1, wherein the power switching unit includes a node to provide the second voltage, and the control unit is arranged to cause the value of the control information to change by an amount proportional to a ratio of current overtime at the node.

7. The apparatus of claim 1, wherein the power switching unit includes a node to provide the second voltage, and the control unit is arranged to cause a settling time of the second voltage to be proportional to a ramp time of a current at the node.

8. The apparatus of claim 1, wherein the control unit is arranged to receive a clock signal and update the value of the error correction information at every one-half of a cycle of the clock signal.

9. The apparatus of claim 1, wherein the control unit is arranged to receive a clock signal and update the value of the error correction information at consecutive edges of the clock signal.

10. An apparatus comprising:
a power switching unit to receive control information and an input voltage to provide an output voltage having a value less than a value of the input voltage;
a signal generator to generate signals having a first frequency based on a reference voltage and a second frequency based on a feedback voltage generated from the output voltage;
an error calculation logic block to generate a first error correction information and a second error correction information based on least on a difference between the first and second frequencies, the first error correction information having a value different from a value of the second error correction information;
a first generator to generate a first code based on the first error correction information;
a second generator to generate a second code based on the first and second error correction information; and
a selector to select the first code to be the control information in a first mode and to select the second code to be the control information in a second mode.

11. The apparatus of claim 10, wherein the error calculation logic block is arranged to receive a clock signal and sample the signals at a sampling frequency based on a frequency of the clock signal to generate the first and second error correction information.

12. The apparatus of claim 11, wherein the error calculation logic block is arranged to update the value of the second error correction information at every one-half period of the clock signal.

13. The apparatus of claim 12, wherein the error calculation logic block includes:
a first time-to-digital converter to generate a first count based on a number of cycles of the first frequency between rising edges of a period of a clock signal, and a second count based on a number of the cycles of the first frequency between falling edges of a period of the clock signal;
a second time-to-digital converter to generate a third count based on a number of the cycles of the second frequency between rising edges of the period of a clock signal, and a fourth count based on a number of the cycles of the second frequency between falling edges of the period of the clock signal; and
a calculator to generate a first coarse count based on a difference between the first and third counts, and a second coarse count based on a difference between the second and fourth counts, wherein the value of the second error correction information is based on one of the first and second coarse counts.

14. The apparatus of claim 12, wherein the signals includes first signals having the first frequency and second signals having the second frequency, and the error calculation logic block includes:
a first time-to-digital converter to generate a first full count based on the phases and frequency of the first signals;
a second time-to-digital converter to generate a second full count based on the phases and frequency of the second signals; and
a calculator to calculate a difference between the first and second full counts to provide the value of the first error correction information.

15. The apparatus of claim 14, wherein the signal generator includes:
a first oscillator to generate the first signals based on a first current having a value based on a value of the reference voltage; and
a second oscillator to generate the second signals based on a second current having a value based on a value of the feedback voltage.

16. The apparatus of claim 10, wherein the first generator is arranged to receive the first error correction information and the control information, such that a value of the first code is a combination of values from the first error correction information and the control information.

17. The apparatus of claim 10, wherein the second generator is arranged to receive the first error correction information, the second control information, and the first code, such that a value of the second code is a combination of values of the first code and a value of one of the first and second error correction information.

18. An apparatus comprising:
a semiconductor die;
a processing unit located on the semiconductor die; and
a voltage controller located on the semiconductor die and coupled to the processing unit, the voltage controller including:
a power switching unit to receive an input voltage and provide an output voltage; and
a control unit to generate control information to control the power switching unit such that a value of the output voltage is less than a value of the input voltage, generate error correction information having a value based on a value of an error in the second voltage, operate in a first mode if the error has a value less than a value of a threshold information and in a second mode if the error has a value greater than the value of the threshold information, and adjust the value of the control information by an amount proportional to the value of the error correction information in the second mode.

19. The apparatus of claim 18, wherein the first mode includes a linear mode, and the second mode includes a non-linear mode.

20. The apparatus of claim 18, wherein the power switching unit includes a node to provide the second voltage, and the voltage controller is arranged to enter the second mode during a load transient event occurring at the node.

21. The apparatus of claim 18, wherein the semiconductor die, the processing unit, and the voltage controller are parts of a system-on-chip (SoC).

22. A method comprising:
receiving an input voltage at a power switching unit;
controlling the power switching unit using control information to provide an output voltage having a value less than a value of the input voltage;
generating error correction information at a control unit, such that a value of the error correction information is based on a value of an error in the output voltage;
generating a first code and a second code based on the error correction information;
selecting the first code to be the control information in a first mode of the control unit if the value of the error is less than a value of a threshold information;
selecting the second code to be the control information in a second mode of the control unit if the value of the error is greater than the value of the threshold information; and
adjusting a value of the control information in the first and second modes by an amount proportional to the value of the error correction information.

23. The method of claim 22, wherein generating the error correction information includes:
generating first signals having a frequency based on a value of a reference voltage;
generating second signals having a frequency based on a version of the output voltage; and
generating the error correction information based on a difference in frequencies and phases between the first signals and the second signals.

24. The method of claim 23, wherein generating the error correction information includes:
sampling the first signals and second signals at a sampling frequency based on a frequency of a clock signal to generate a first count based on the sampling of the first signals and a second count based on the sampling of the second signals; and
calculating the value of the error correction information based on the first and second counts.

25. The method of claim 24, wherein generating the error correction information includes updating the first and second counts at every one-half period of the clock signal.
